(19) United States
(12) Patent Application Publication
(10) Pub. No.: US 2018/0059775 A1
(43) Pub. Date: Mar. 1, 2018

(54) ROLE-BASED PROVISION OF VIRTUAL REALITY ENVIRONMENT

(71) Applicant: Accenture Global Solutions Limited, Dublin (IE)

(72) Inventors: Ian C. SHAFER, Tabernacle, NJ (US); Spencer AMER, New York, NY (US); Rishi BATRA, Noida (IN); Daniel L. KANG, Chicago, IL (US); Ruth Ann LANIER, New York, NY (US)

(21) Appl. No.: 15/596,567

(22) Filed: May 16, 2017

(30) Foreign Application Priority Data
Aug. 23, 2016 (IN) 201641028617

(51) Int. Cl. G06F 3/01; G06T 11/60

(52) U.S. Cl. CPC G06F 3/011; G06T 11/60

(57) ABSTRACT

A method may include receiving, by a virtual reality (VR) platform, role information identifying a particular role associated with a user device; and/or identifying, by the VR platform, a virtual reality scene to be provided to the user device based on the role information, the virtual reality scene including a plurality of objects with sets of objects that are associated with information identifying respective roles associated with the sets of objects. A role may be associated with a corresponding set of objects that are relevant to a person performing the role. The method may include identifying, by the VR platform, a particular set of objects, of the sets of objects, associated with the particular role to be provided to the user device as a part of the virtual reality scene; and/or providing, by the VR platform the virtual reality scene including the particular set of objects.

### RELATED APPLICATION

This application claims priority under 35 U.S.C. §119 to Indian Patent Application No. 201641028617, filed on Aug. 23, 2016, the content of which is incorporated by reference herein in its entirety.

### BACKGROUND

Virtual reality (VR) may refer to computer technologies that use software to generate realistic images, sounds, and other sensations that replicate a real environment (or create an imaginary setting), and simulate a user's physical presence in the environment. VR may be defined as a realistic and immersive simulation of a three-dimensional environment, created using interactive software and hardware, and experienced or controlled by movement of the body. For example, in a VR scene, a person using special electronic equipment, such as a helmet with a display inside, goggles with a display inside, or the like, may interact with a computer-generated simulation of a three-dimensional image or environment in a seemingly real or physical way.

### SUMMARY

A method may include receiving, by one or more devices of a virtual reality (VR) platform, role information identifying a particular role associated with a user device; identifying, by the one or more devices of the VR platform, a virtual reality scene to be provided to the user device based on the role information, the virtual reality scene including a plurality of objects, sets of objects, of the plurality of objects, being associated with information identifying respective roles associated with the sets of objects, a role, of the respective roles, being associated with a corresponding set of objects based on the corresponding set of objects being relevant to a person performing the role; identifying, by the one or more devices of the VR platform, a particular set of objects, of the sets of objects, to be provided to the user device as a part of the virtual reality scene, the particular set of objects being associated with the particular role; and/or providing, by the one or more devices of the VR platform and to the user device, the virtual reality scene including the particular set of objects.

A device may determine role information identifying a particular role associated with a user device; identify a virtual reality scene to be provided to the user device based on the role information and/or the user device, the virtual reality scene including a plurality of objects, sets of objects, of the plurality of objects, being associated with information identifying respective roles associated with the sets of objects; identify a particular set of objects, of the sets of objects, to be provided to the user device as a part of the virtual reality scene based on the particular role; and/or provide, to the user device, the virtual reality scene including the particular set of objects.

A non-transitory computer-readable medium may store one or more instructions that, when executed by one or more processors, cause the one or more processors to determine role information identifying a role associated with a user device, the role relating to a virtual reality scene to be provided to a user associated with the user device; identify the virtual reality scene to be provided to the user device based on the role information, the virtual reality scene including a plurality of objects, sets of objects, of the plurality of objects, being associated with information identifying respective roles associated with the sets of objects; identify a particular set of objects, of the sets of objects, to be provided to the user device as a part of the virtual reality scene based on the role; and/or provide, to the user device, the virtual reality scene including the particular set of objects to permit the user device to provide the virtual reality scene to the user.

### BRIEF DESCRIPTION OF THE DRAWINGS

FIGS. 1A and 1B are diagrams of an overview of an example implementation described herein;

FIG. 2 is a diagram of an example environment in which systems and/or methods, described herein, may be implemented;

FIG. 3 is a diagram of example components of one or more devices of FIG. 2; and

FIG. 4 is a flow chart of an example process for providing a virtual reality scene based on a role associated with a viewer of the virtual reality scene.

### DETAILED DESCRIPTION

The following detailed description of example implementations refers to the accompanying drawings. The same reference numbers in different drawings may identify the same or similar elements.

Change management may refer to any approach to or process for transitioning individuals, teams, and organizations using methods intended to re-direct the use of resources, business processes, budget allocations, or other modes of operation that significantly reshape a company or organization. To facilitate change management, an entity may provide information regarding changes to the modes of operation, such as information regarding changing requirements, processes, or the like. Different users, people, workers, devices, or the like, may be affected by changes in different ways. As one example, in a clinical environment undergoing a transition to a paperless filing system, a patient may be differently affected than a nurse, and a nurse may be differently affected than a doctor. It may be helpful to employees of the clinical environment to experience predicted results of the changes with regard to different roles of the clinical environment (e.g., patient, nurse, doctor, etc.). Additionally, or alternatively, it may be useful to provide information regarding the changes to appropriate parties. For example, a nurse may be provided information regarding changes that affect the nurse, and so on. As described herein, a set of information regarding changes and/or predicted results of changes of a change management operation to be provided to a user is referred to as a “scene.”

However, generating multiple, different scenes regarding different roles may be time consuming and resource intensive (e.g., memory resources, processor resources, organizational resources, etc.). Furthermore, providing the entirety of a scene to users that may be associated with different roles is resource intensive and could create security issues. For example, a user associated with a particular role may access confidential information, included in the scene, that should not be provided to users not associated with the particular role.

Implementations described herein permit a VR platform to provide portions of a scene that are customized based on roles associated with user devices to which the portions are to be provided. For example, the VR platform may identify a role associated with a user device, and may selectively provide a portion of the scene to the user device for display, via a VR scene, to a user. The portion of the scene that is provided to the user may be relevant to the role. For example, continuing the clinical environment example from above, when a user is associated with a role of “nurse,” the portion of the scene may relate to inputting and accessing paperless patient files. Further, the portion of the scene may exclude, from the VR scene, other portions of the scene that are irrelevant to the role of nurse (e.g., accounting information, information regarding insurance compliance, etc.).

The roles associated with the users and/or user devices may be determined based on user input, based on locations of the user devices (e.g., based on global positioning systems of the user devices), based on credentials associated with the users, based on a determination by the VR platform, based on surroundings of the users (e.g., as the VR scene is provided via the user devices), or the like.

By selectively providing portions of the scene based on roles, the VR platform conserves computing resources that would otherwise be used to provide the entire scene, and automates the process of generating different scenes for different roles, which would otherwise be performed by a human in a subjective and time-consuming fashion. Furthermore, by conveying change management information using a VR scene, the VR platform may improve user engagement with and retention when the change management information is presented to the user. Still further, the VR platform may improve security of information associated with the scene by selectively providing information based on the roles.

In some implementations, use of the VR platform may reduce the cost of implementing change management by identifying shortcomings, issues, unintended consequences, etc., associated with a proposed change prior to actually implementing the change. Furthermore, VR may provide a useful and intuitive interface for provision of information regarding roles and change management processes. Change management, by its nature, involves shifting requirements, expectations, and tasks. By iteratively updating the VR scene so that the VR scene is in synch with the shifting requirements, expectations, and tasks, user retention of such information may be improved. Further, the VR platform (or an administrator device associated with the VR platform) may provide push notifications to relevant parties as the VR scene is modified, which may improve comprehension and retention of modifications to the change management process.

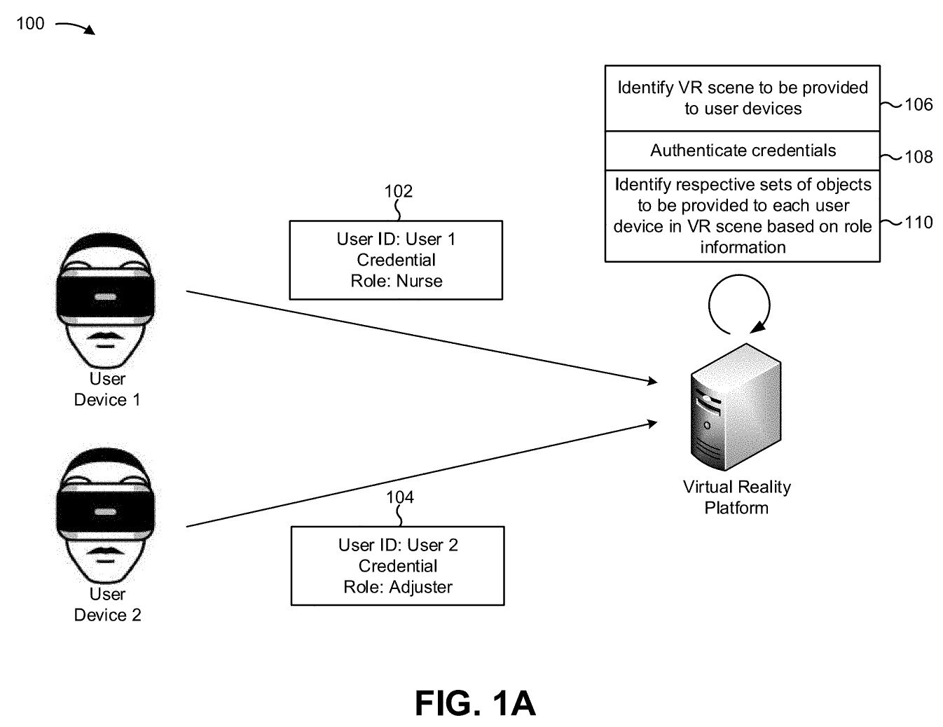

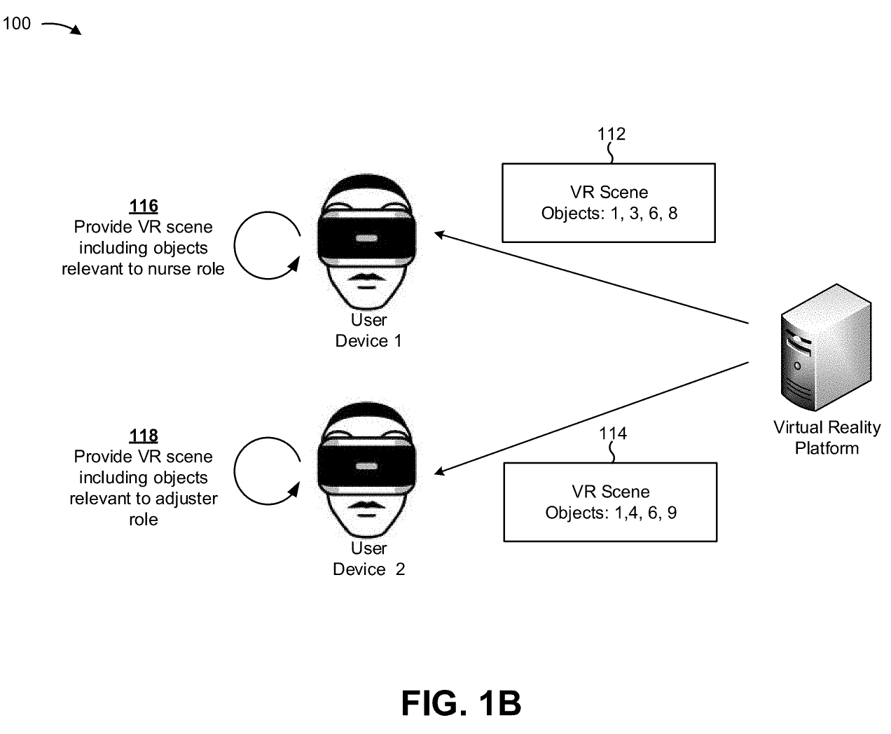

FIGS. 1A and 1B are diagrams of an overview of an example implementation 100 described herein. Implementation 100 includes a user associated with a user device 1, a user associated with a user device 2, and a virtual reality (VR) platform.

As shown in FIG. 1A, user device 1 and user device 2 may provide respective user identifiers (ID), credentials (e.g., a password, a passphrase, a character string, or the like), and role information. For example, and as shown by reference number 102, the user device associated with user 1 may provide a user ID (user 1), a credential, and a role (nurse) to the VR platform. As shown by reference number 104, the user device associated with user 2 may provide a user ID (user 2), a credential, and a role (adjuster) to the VR platform. Based on the user ID, credential, and/or role information, the VR platform may determine role information identifying respective roles associated with each user device.

As used herein, a role refers to an attribute, string of characters, or value corresponding to a set of objects of a virtual reality scene. For example, in a particular environment or scenario, roles may be mapped to a variety of occupations or tasks relating to the particular environment or scenario, and a VR scene regarding the particular environment or scenario may include objects that are relevant to some roles and irrelevant to other roles based on responsibilities and actions associated with the occupations or tasks.

As shown by reference number 106, based on the role information provided by the user devices associated with user 1 and/or user 2, the VR platform may identify a VR scene to be provided to the user devices 1 and 2. The VR platform may identify the VR scene based on the user identifiers, based on locations of the user devices, based on the credentials, or the like. The VR scene may relate to an environment or scenario, and may include objects that allow the users of the user devices 1 and 2 to interact with the environment or scenario (e.g., after one or more change management actions are performed). As shown by reference number 108, the VR platform may authenticate the credentials provided by user devices 1 and 2. For example, the VR platform may determine whether user devices 1 and 2 have permission to access the VR scene associated with the respective roles, and may provide the VR scene based on determining that user devices 1 and 2 have permission to access the VR scene.

As shown by reference number 110, the VR platform may identify sets of objects (e.g., of a plurality of objects included in the VR scene), to be provided to each user device associated with user 1 and/or user 2, in the VR scene. For example, the VR platform may identify a first set of objects for user device 1 and a second set of objects for user device 2. An object may include information to be provided as part of the VR scene. For example, an object may include an animation, a two-dimensional (2D) object, a three-dimensional (3D) object, an interactive set of information, an audio recording, a guide, or any other information that may be provided as part of the VR scene. In some cases, a VR scene object may correspond to a physical object in the surroundings of a user device (e.g., based on a physical identifier or the like) as described in more detail elsewhere herein.

In some implementations, although user device 1 is associated with the nurse role, user 1 may or may not be a nurse. For example, user 1 may be an entity that wants to learn about a nurse's role. By tailoring the VR scene for the nurse role, the VR platform provides a resource-efficient and immersive way for the user to learn about the nurse's role. Furthermore, using VR as compared to traditional methods of education (e.g., instructional videos, checklists, written summaries, training classes, etc.) may improve retention of information regarding the role associated with the portion of the VR scene.

The VR scene may include a plurality of objects. User devices may be provided with different portions of the VR scene, where each portion includes different objects of the plurality of objects. For example, one or more of the objects provided to user device 1 may be different from objects that are provided to user device 2. By providing different sets of objects to different user devices, the VR platform enables customization of the VR scene for different roles without generating different VR scenes from scratch.

As shown in FIG. 1B, and by reference number 112, the VR platform may provide VR scene objects 1, 3, 6, and 8 to user device 1. As shown by reference number 114, the VR platform may provide VR scene objects 1, 4, 6, and 9 to user device 2. For example, objects 1 and 6 may be relevant to both of the roles (nurse and adjuster), objects 3 and 8 may be relevant to the nurse role and not the adjuster role, and objects 4 and 9 may be relevant to the adjuster role and not the nurse role.

As shown by reference number 116, user device 1 may provide, to user 1, the VR scene including objects relevant to the nurse role. As shown by reference number 118, user device 2 may provide, to user 2, the VR scene including objects relevant to an adjuster role. By selectively providing portions of the scene (e.g., scene objects) based on roles, the VR platform conserves computing resources that would otherwise be used to provide the entire scene. Furthermore, by providing the portions of the scene for generation of a virtual reality scene, the VR platform may improve user engagement with and retention of information presented to the user. Still further, the VR platform may improve security of information associated with the scene by selectively providing information based on the roles.

As indicated above, FIGS. 1A and 1B are provided merely as an example. Other examples are possible and may differ from what was described with regard to FIGS. 1A and 1B.

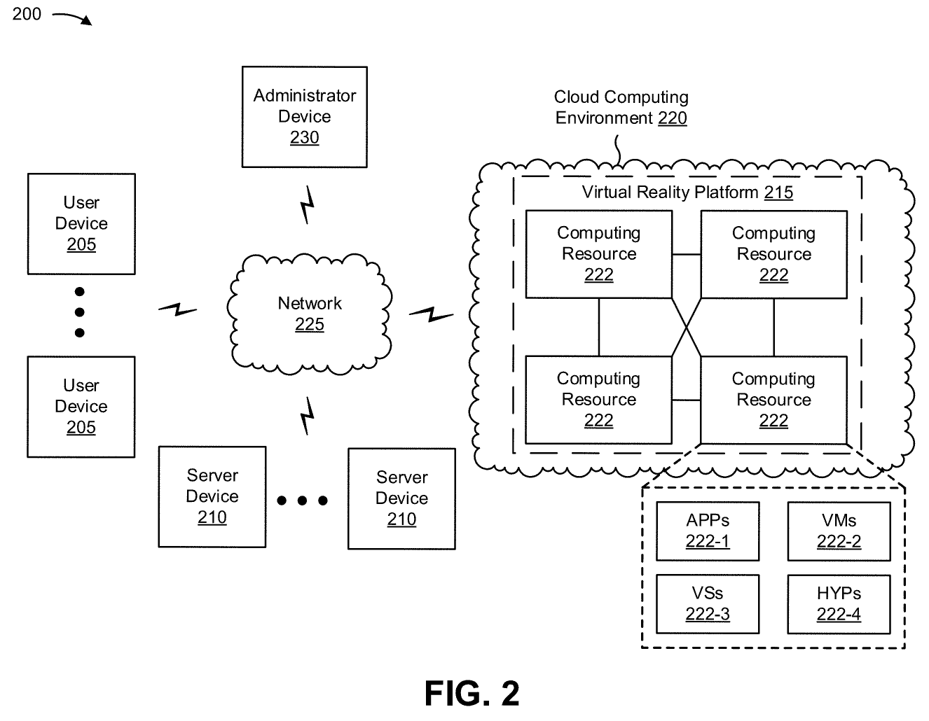

FIG. 2 is a diagram of an example environment 200 in which systems and/or methods described herein may be implemented. As shown in FIG. 2, environment 200 may include one or more user devices 205, one or more server devices 210, a VR platform 215 hosted within a cloud computing environment 220, and a network 225. Devices of environment 200 may interconnect via wired connections, wireless connections, or a combination of wired and wireless connections.

User device 205 includes one or more devices capable of receiving, generating, storing, processing, and/or providing information, such as a VR scene. For example, user device 205 may include a communication and computing device, such as a mobile phone (e.g., a smart phone, a radiotelephone, etc.), a laptop computer, a tablet computer, a handheld computer, a wearable communication device (e.g., a virtual reality headset, a pair of smart eyeglasses, etc.), a virtual reality device, or a similar type of device. User device 205 may generate and/or provide at least a portion of a VR scene that is generated and/or modified by VR platform 215.

Server device 210 includes one or more devices capable of receiving, collecting, obtaining, gathering, storing, processing, and/or providing information associated with a VR scene. For example, server device 210 may include a server or a group of servers.

VR platform 215 includes one or more devices capable of receiving, determining, processing, storing, and/or providing information associated with a VR scene. For example, VR platform 215 may include a server or a group of servers. In some implementations, VR platform 215 may receive, store, and/or provide information regarding a scene to be provided to one or more user devices 205.

In some implementations, VR platform 215 may be associated with a VR application. The VR application may be a computer program designed to perform a group of coordinated functions, tasks, or activities for the VR platform 215. For example, the VR application may integrate VR platform 215 with a graphical user interface (GUI) of VR platform 215. In some implementations, the VR application may be installed on user device 205.

In some implementations, VR platform 215 may be associated with a GUI. The GUI may allow a user to interact with user device 205 through graphical icons, visual indicators, typed command labels, text navigation, or the like. A user may interact with the GUI through direct manipulation of the graphical icons, visual indicators, typed command labels, text navigation, or the like. In some implementations, the GUI may provide role-based user access to learning and/or push notifications.

In some implementations, VR platform 215 may be associated with one or more operating systems (e.g., iOS, Android, or the like). In some implementations, VR platform 215 may be associated with application middleware. The application middleware may be a software layer that ties the one or more operating systems and the VR application. The application middleware also may connect software components in VR platform 215.

In some implementations, VR platform 215 may be associated with a server device 210 and/or a database. The server device 210 and/or database may store content updates provided by a VR platform 215 administrator. For example, the server device 210 and/or database may store content updates that are pushed into VR platform 215 by administrator device 230.

In some implementations, VR platform 215 may be associated with an application programming interface (API) that defines how routines and protocols may be used when the GUI is programmed. The API may call role-based information from the database and/or server device 210.

In some implementations, VR platform 215 may be associated with a content management platform and/or administrator device, where new content and notifications may be designed for change management and training.

In some implementations, as shown, VR platform 215 may be hosted in cloud computing environment 220. Notably, while implementations described herein describe VR platform 215 as being hosted in cloud computing environment 220, in some implementations, VR platform 215 may not be cloud-based or may be partially cloud-based.

Cloud computing environment 220 includes an environment that hosts VR platform 215. Cloud computing environment 220 may provide computation, software, data access, storage, etc. services that do not require end-user (e.g., user device 205) knowledge of a physical location and configuration of system(s) and/or device(s) that hosts VR platform 215. As shown, cloud computing environment 220 may include a group of computing resources 222 (referred to collectively as “computing resources 222” and individually as “computing resource 222”).

Computing resource 222 includes one or more personal computers, workstation computers, server devices, or another type of computation and/or communication device. In some implementations, computing resource 222 may host VR platform 215. The cloud resources may include compute instances executing in computing resource 222, storage devices provided in computing resource 222, data transfer devices provided by computing resource 222, etc. In some implementations, computing resource 222 may communicate with other computing resources 222 via wired connections, wireless connections, or a combination of wired and wireless connections.

As further shown in FIG. 2, computing resource 222 may include a group of cloud resources, such as one or more applications (“APPs”) 222-1, one or more virtual machines (“VMs”) 222-2, virtualized storage (“VSs”) 222-3, one or more hypervisors (“HYPs”) 222-4, or the like.

Application 222-1 includes one or more software applications that may be provided to or accessed by user device 205. Application 222-1 may eliminate a need to install and execute the software applications on user device 205. For example, application 222-1 may include software associated with VR platform 215 and/or any other software capable of being provided via cloud computing environment 220. In some implementations, one application 222-1 may send/receive information to/from one or more other applications 222-1, via virtual machine 222-2.

Virtual machine 222-2 includes a software implementation of a machine (e.g., a computer) that executes programs like a physical machine. Virtual machine 222-2 may be either a system virtual machine or a process virtual machine, depending upon use and degree of correspondence to any real machine by virtual machine 222-2. A system virtual machine may provide a complete system platform that supports execution of a complete operating system (“OS”). A process virtual machine may execute a single program, and may support a single process. In some implementations, virtual machine 222-2 may execute on behalf of a user (e.g., user device 205), and may manage infrastructure of cloud computing environment 220, such as data management, synchronization, or long-duration data transfers.

Virtualized storage 222-3 includes one or more storage systems and/or one or more devices that use virtualization techniques within the storage systems or devices of computing resource 222. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 222-4 provides hardware virtualization techniques that allow multiple operating systems (e.g., “guest operating systems”) to execute concurrently on a host computer, such as computing resource 222. Hypervisor 222-4 may present a virtual operating platform to the guest operating systems, and may manage the execution of the guest operating systems. Multiple instances of a variety of operating systems may share virtualized hardware resources.

Network 225 includes one or more wired and/or wireless networks. For example, network 225 may include a cellular network (e.g., a long-term evolution (LTE) network, a 3G network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

Administrator device 230 includes one or more devices capable of receiving, generating, storing, processing, or providing information associated with a virtual reality scene. For example, administration device 230 may include a server device, a group of server devices, one or more of the devices associated with user device 205, and/or the like. In some implementations, administration device 230 may manage push notifications for user device 205 based on updates or changes to a virtual reality scene or a role associated with user device 205. For example, administration device 230 may manage information regarding user devices 205 associated with particular roles, changes to the particular roles, and/or modifications to the VR scene based on the changes to the particular role. Administration device 230 may provide a push notification to user device 205 regarding VR scenes to be viewed by a user of user device 205. In some implementations, administration device 230 may be included in or may be a part of VR platform 215.

The number and arrangement of devices and networks shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

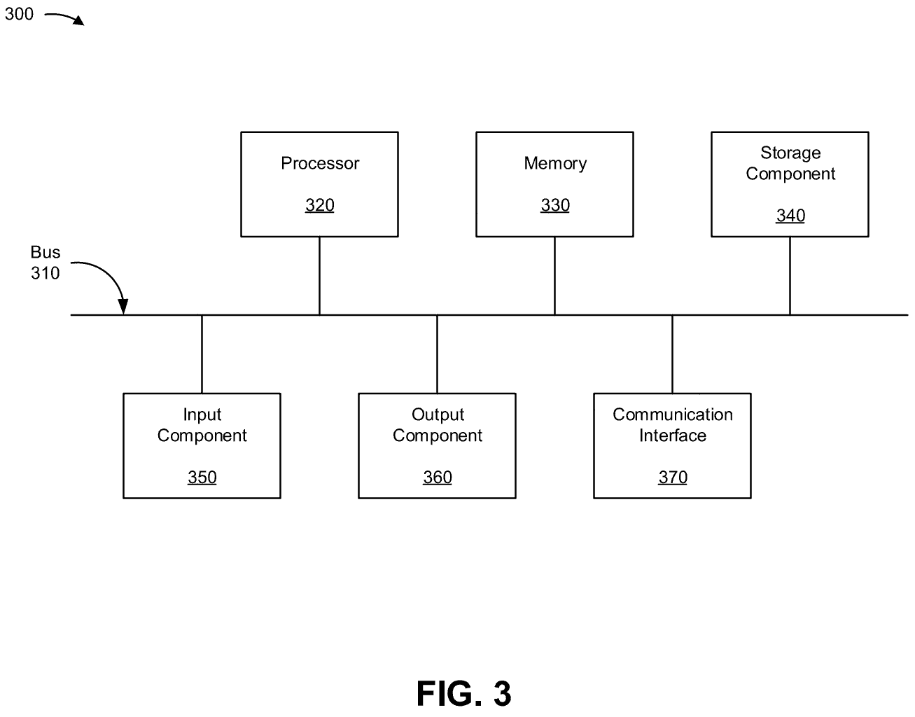

FIG. 3 is a diagram of example components of a device 300. Device 300 may correspond to user device 205, server device 210, computing resource 222, and/or administration device 230. In some implementations, user device 205, server device 210, and/or computing resource 222 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 takes the form of a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

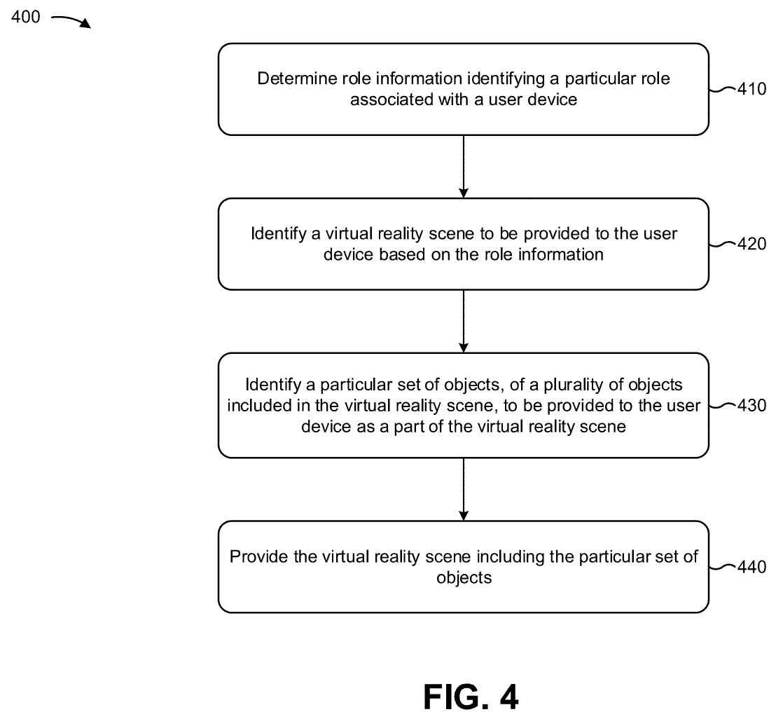

FIG. 4 is a flow chart of an example process 400 for providing a virtual reality scene based on a role associated with a viewer of the virtual reality scene. In some implementations, one or more process blocks of FIG. 4 may be performed by VR platform 215. In some implementations, one or more process blocks of FIG. 4 may be performed by another device or a group of devices separate from or including VR platform 215, such as user device 205, server device 210, or administration device 230.

As shown in FIG. 4, process 400 may include determining role information identifying a particular role associated with a user device (block 410). For example, VR platform 215 may receive or determine role information identifying a particular role associated with one or more user devices 205. In some implementations, the role information may identify a role associated with user device 205. A role may correspond to a set of objects of a VR scene. VR platform 215 may provide the VR scene, including the set of objects, based on user device 205 being associated with the role, as described in more detail below.

In some implementations, VR platform 215 may receive the role information from user device 205. For example, a user of user device 205 may specify role information so that the user can view a VR scene regarding a particular role. In this way, VR platform 215 conserves processor resources that would be used to determine the particular role without the user input.

In some implementations, VR platform 215 may automatically determine role information based on user device 205. For example, VR platform 215 may store information identifying roles for particular user devices 205, particular types of user devices 205, user devices 205 located at a particular place, or the like. In some implementations, VR platform 215 may identify a type or identity of user device 205 and select the role for user device 205 based on the stored information.

In some implementations, VR platform 215 may automatically determine role information for a particular user device 205. For example, the particular user device 205 may be associated with a particular device identifier (e.g., a phone number, a network address, account information, etc.), and VR platform 215 may determine role information based on roles associated with device identifiers. In some implementations, VR platform 215 may store information identifying roles to be assigned for device identifiers (e.g., based on particular mappings of roles and device identifiers, based on characteristics of the device identifiers, such as domain names of an email address, etc.), and may determine the role information based on the stored information.

In some implementations, VR platform 215 may automatically determine role information for a particular type of user device 205. For example, assume that a first type of user device 205 is associated with users of a type that are to view VR scenes for a first set of roles, and that a second type of user device 205 is associated with users of a type that are to view VR scenes for a second set of roles. In that case, VR platform 215 may determine role information for a user device 205 of the first type indicating that the user device 205 of the first type is associated with the first set of roles, and may determine role information for a user device 205 of the second type indicating that the user device 205 of the second type is associated with the second set of roles (e.g., based on information mapping the type of user devices 205 to the respective sets of roles). In this way, VR platform 215 may conserve processor, human, and organizational resources that would otherwise be used to specify role information for individual user devices 205 of particular types.

In some implementations, VR platform 215 may automatically determine role information for a user device 205 located at a particular place. For example, VR platform 215 may identify a location of user device 205, and may identify roles that are to be provided to user devices 205 at the location. VR platform 215 may identify the location based on global positioning information provided by user device 205, based on an image or video of surroundings of user device 205, based on user input, and/or the like. In this way, VR platform 215 identifies VR scenes associated with particular roles to be provided to users in a particular place.

In some implementations, the role information may identify a particular role. For example, a role may be associated with a job, a worker, a fictional character, or the like. As an example, in a medical office, a role may include a nurse, a nurse practitioner, an insurance processor, an x-ray tech, a doctor, a patient, a receptionist, or the like. In some implementations, VR platform 215 may modify the VR scene based on the particular role and/or may selectively include particular content in the VR scene, such that objects relating to the particular role are provided in the VR scene and objects unrelated to the particular role are excluded from the VR scene.

As shown in FIG. 4, process 400 may include identifying a virtual reality scene to be provided to the user device based on the role information (block 420). For example, VR platform 215 may identify a VR scene to be provided to user device 205 based on the role information. In some implementations, the VR scene may include a plurality of objects, of which different sets of objects may be provided to user devices 205 associated with different roles.

In some implementations, VR platform 215 may identify the VR scene to be provided based on the role information, based on an identity of user device 205 and/or the user, and/or based on other information. For example, VR platform 215 may determine that user device 205 or a user of user device 205 is associated with a particular organization, and may provide a VR scene associated with the particular organization. In other words, VR platform 215 may be associated with multiple organizations and may provide, to user device 205, a VR scene associated with a first organization and not associated with a second organization when the user of user device 205 is associated with the first organization.

As another example, VR platform 215 may determine that user device 205 is located at a particular place (e.g., a place of business associated with an organization, a training center, or the like), and may provide a VR scene associated with the particular place. In other words, VR platform 215 may store VR scenes associated with multiple places. VR platform 215 may identify the location of user device 205 by receiving location information from user device 205, querying another device regarding the location of user device 205, or the like. VR platform 215 may identify a VR scene associated with the location of user device 205 and may provide this VR scene to user device 205. In this way, VR platform 215 may improve operation of the virtual reality experience and efficiently use computing resources of VR platform 215 by providing a VR scene that is associated with the current surroundings of user device 205.

In some implementations, VR platform 215 may identify the VR scene to be provided based on an instruction from an administrator. For example, an administrator (or a device associated with an administrator) may generate a VR scene, and may provide the VR scene to VR platform 215 for provision to user devices 205. The VR scene may be associated with information identifying which objects, of the VR scene, are to be provided to user devices 205 with particular roles. VR platform 215 may determine role information for user devices 205 to receive the VR scene. For example, VR platform 215 may request the role information, may refer to stored role information that was previously provided by the user devices 205 or another device, and/or the like.

As shown in FIG. 4, process 400 may include identifying a particular set of objects, of a plurality of objects included in the virtual reality scene, to be provided to the user device as a part of the virtual reality scene (block 430). For example, VR platform 215 may identify a particular set of objects, of a plurality of objects included in the virtual reality scene, to be provided to the user device as a part of the virtual reality scene. In some implementations, the VR scene may be associated with a plurality of objects, and different sets of objects may be associated with different roles. For example, VR platform 215 may store information identifying one or more roles associated with each object of the VR scene.

In some implementations, there may be some overlap between the sets of objects corresponding to the different roles, as described in connection with FIG. 1B, above. For example, certain objects may be included in a VR scene tailored for two or more different roles. By providing the certain objects in connection with each role, rather than generating two different VR scenes, computational and organizational resources of VR platform 215 are saved that would otherwise be used to generate two different VR scenes. For example, VR platform 215 may store information identifying the VR scene, including the plurality of objects, and may selectively add objects to or remove objects from the VR scene based on the role associated with user device 205.

In some implementations, VR platform 215 may provide the VR scene, including the objects, to user device 205. For example, VR platform 215 may provide a data stream of the VR scene to user device 205 (e.g., as user device 205 provides the VR scene to the user). In this way, VR platform 215 conserves storage resources of user device 205. Additionally, or alternatively, VR platform 215 may provide the VR scene to user device 205 before user device 205 provides the VR scene to the user. For example, VR platform 215 may provide information identifying the VR scene and the plurality of objects, and user device 205 may store the information identifying the VR scene and the plurality of objects. In some implementations, user device 205 may subsequently provide the VR scene, including particular objects corresponding to a particular role. For example, user device 205 may provide the VR scene including the particular objects based on receiving information from VR platform 215 identifying the particular objects to be provided, or based on receiving information identifying the role and identifying the particular objects to be provided based on the role. In this way, VR platform 215 conserves network resources that would otherwise be used to provide the VR scene to user device 205 on the fly.

As shown in FIG. 4, process 400 may include providing the virtual reality scene including the particular set of objects (block 440). For example, VR platform 215 may provide the VR scene including the particular set of objects corresponding to the role associated with user device 205. In some implementations, VR platform 215 may stream the VR scene to user device 205. Additionally, or alternatively, VR platform 215 may provide the VR scene and the plurality of objects to user device 205 before user device 205 provides the VR scene to the user. For example, VR platform 215 may receive information from user device 205 identifying a role. VR platform 215 may identify objects to be included in the VR scene based on the role. VR platform 215 may provide information identifying the objects to be included to user device 205, and user device 205 may provide the scene including the objects. Additionally, or alternatively, user device 205 may filter objects, other than the objects to be included, from the VR scene. In this way, user device 205 reduces bandwidth usage and conserves processor resources of VR platform 215.

In some implementations, user device 205 may identify physical objects in a vicinity of user device 205 to identify or provide as part of a VR scene for a particular role. For example, the physical objects may be associated with respective physical identifiers (e.g., RFID tags, may be detected using acoustic, optical, radio-frequency transponders, etc.) that indicate that the physical objects are associated with a particular role. When user device 205 provides the VR scene for the particular role, the physical object may be highlighted, may be associated with information provided via the virtual reality environment, or the like. For example, when people associated with different roles are to access files on a particular machine in an office, the particular machine may be tagged with a physical identifier, and may therefore be provided (e.g., highlighted, etc.) in the VR scene as tailored for the different roles. Additionally, or alternatively, VR platform 215 may determine that the physical object is included in the VR scene, and may identify particular information to provide as part of the VR scene (e.g., information indicating how to use the physical object, a warning regarding the physical object, etc.). In this way, VR platform 215 adjusts a VR scene based on information that is relevant to physical objects in a vicinity of user device 205, which conserves computational resources that would otherwise be used to provide information regarding irrelevant objects or irrelevant portions of the scene. As used herein, a vicinity may refer to any location relevant to the VR scene that a user may experience. For example, in some cases, a vicinity may be a few feet (e.g., an office), and in other cases the vicinity may be measured in inches (e.g., for a surgical procedure) or yards (for a large room or warehouse).

In some implementations, VR platform 215 may modify a VR scene based on surroundings of user device 205. For example, user device 205 may monitor locations or surroundings of user device 205 at which user device 205 is located during a period of time (e.g., a number of days, weeks, hours, etc.). VR platform 215 (or user device 205) may configure the VR scene and/or the particular set of objects to be provided in the VR scene based on the locations or surroundings. For example, VR platform 215 may provide the particular set of objects corresponding to objects included in the surroundings of the user device 205. Additionally, or alternatively, VR platform 215 may configure the VR scene to be provided by a first user device 205 based on monitoring locations or surroundings of a second user device 205, which conserves processor and organizational resources that would otherwise be used to independently configure the VR scene for the first user device 205.

In some implementations, VR platform 215 may modify a VR scene based on environmental information. For example, assume that a first set of objects (e.g., portion of a scene) is to be provided to user device 205 associated with a first role, and assume that a second set of objects is to be provided to user device 205 associated with a second role. For example, the first role may be associated with the first set of objects, and the second role may be associated with the second set of objects, based on a planned change management approach. Now assume that VR platform 215 receives environmental information that identifies a change in the planned change management approach (e.g., a reorganization, change in plans, change in procedures, divestiture, natural disaster, departure of key staff, etc.).

In such a case, VR platform 215 may identify modifications to the scene based on the environmental information. For example, VR platform 215 may add one or more objects to the first set and/or the second set or remove one or more objects from the first set and/or the second set. As another example, VR platform 215 may provide the first set of objects to user devices 205 associated with the second role, and/or may provide the second set of objects to user devices 205 associated with the first role. As yet another example, VR platform 215 may permit user devices 205 associated with roles other than the first role or the second role to view the first set of objects and/or the second set of objects. Additionally, or alternatively, VR platform 215 may receive or determine information identifying one or more modified objects associated with a particular role, and may provide the one or more modified objects to user device 205 for inclusion in the VR scene. In this way, VR platform 215 adapts a VR scene based on environmental information, which improves relevance of the virtual reality environment and conserves computational resources that would otherwise be used to provide irrelevant information in the VR scene, or to generate an entirely new set of VR scenes for provision to user devices 205 associated with the various roles.

In some implementations, VR platform 215 may provide a push notification to user device 205 to cause user device 205 to provide a portion of a scene. For example, the push notification may include the portion of the scene. As another example, the push notification may request input of a credential and/or selection of a role. Based on the input, VR platform 215 may provide the portion of the scene. As yet another example, VR platform 215 (or administration device 230) may provide a push notification based on receiving an update to a scene, a role, and/or change management process. For example, when VR platform 215 (or administration device 230) determines that permissions for a particular role have been changed, VR platform 215 (or administration device 230) may provide a push notification to user device 205 associated with the particular role.

Additionally, or alternatively, VR platform 215 or administration device 230 may determine that objects to be provided in association with a particular role have been changed, and may provide a push notification to user devices 205 associated with the particular role to cause the user devices 205 to provide the VR scene with the changed objects. Additionally, or alternatively, VR platform 215 may provide push notifications based on particular roles. For example, VR platform 215 may provide push notifications to only user devices 205 associated with impacted roles or to all user devices 205 associated with VR platform 215 (e.g., based on a preference indicated by an administrator). Additionally, or alternatively, VR platform 215 may assign a role to a user based on a push notification. For example, VR platform 215 may provide a notification to user device 205 identifying a role to be performed by the user.

By providing push notifications regarding a change management process, VR platform 215 increases a likelihood that users view relevant scenes. Further, by targeting the push notifications to appropriate parties, VR platform 215 conserves computational resources that would otherwise be used to provide this information in an untargeted or broadcast manner. Still further, providing push notifications regarding changes in the change management process may improve effectiveness of the change management process, and VR may provide a useful and intuitive interface for information regarding the change management process.

As an example process for user device 205, user device 205 may install an application for viewing virtual reality scenes, and may launch the application. In such a case, user device 205 may receive or determine information that identifies a role, based on which to access portions of the scenes. For example, a user may input information that identifies the role. As another example, user device 205 may determine the role (e.g., based on a location of the user device, based on a credential inputted by the user, based on a device type of the device, based on a configuration of the device, based on an identifier of the device, based on information associated with the application, etc.).

Continuing the above example process, user device 205 may enter a virtual reality viewing mode. For example, user device 205 may be inserted into, or may be connected to, a virtual reality headset. As another example, a virtual reality viewing mode of user device 205 may be activated. In some implementations, user device 205 may provide an introductory scene for the user (e.g., when the user is a first-time user). The introductory scene may include instructions for interacting with the virtual reality environment, or the like. User device 205 may provide information that identifies the role to VR platform 215.

Based on the information that identifies the role, VR platform 215 may provide a portion of a scene to user device 205. The portion of the scene may include a subset of objects included in the scene, and the subset of objects may be selected based on the role. For example, a user associated with a leadership role may receive executive summary and performance dashboards, whereas an end user (e.g., an employee or consumer) may receive information pertinent to job assistance, training, etc. User device 205 may provide the portion of the scene, as a virtual reality scene, to the user. The user may interact with the portion of the scene. When the scene relates to a change management process, the portion of the scene may relate to a change in an environment, an operation, and/or a process for an entity with the role identified for user device 205.

In some implementations, VR platform 215 may be associated with an information on demand (IoD) implementation. For example, the IoD implementation may provide an information interface between users of user device 205 and an administrator or leader. As a more particular example, assume that a user needs to access a particular interface or dashboard that only an administrator or leader has permission to access. In such a case, the IoD implementation may provide a notification to the administrator or leader for the administrator or leader to approve access to the particular interface or dashboard. In some implementations, once approved, the dashboard (or other relevant information) may be made available to the user (e.g., for a limited period of time).

In some implementations, VR platform 215 may be associated with a crowd-based implementation for groups of users. For example, VR platform 215 may host a chat room or virtual lobby wherein users from different locations can view VR scenes, comment on VR scenes, interact with each other, exchange ideas or thoughts regarding VR scenes, and/or the like.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

By selectively providing portions of a scene based on roles, VR platform 215 conserves computing resources that would otherwise be used to provide the entire scene, and automates the process of generating different scenes for different roles, which would otherwise be performed by a human in a subjective and time-consuming fashion. Furthermore, by using the VR scene to convey change management information, VR platform 215 may improve user engagement with and retention of information presented to the user. Still further, VR platform 215 may improve security of information associated with the scene by selectively providing information based on the roles.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

Certain user interfaces have been described herein and/or shown in the figures. A user interface may include a graphical user interface, a non-graphical user interface, a text-based user interface, etc. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method, comprising:
receiving, by one or more devices of a virtual reality (VR) platform, role information identifying a particular role associated with a user device;
identifying, by the one or more devices of the VR platform, a virtual reality scene to be provided to the user device based on the role information,
the virtual reality scene including a plurality of objects,
sets of objects, of the plurality of objects, being associated with information identifying respective roles associated with the sets of objects,
a role, of the respective roles, being associated with a corresponding set of objects based on the corresponding set of objects being relevant to a person performing the role;
identifying, by the one or more devices of the VR platform, a particular set of objects, of the sets of objects, to be provided to the user device as a part of the virtual reality scene,
the particular set of objects being associated with the particular role; and
providing, by the one or more devices of the VR platform and to the user device, the virtual reality scene including the particular set of objects.

2. The method of claim 1, where providing the virtual reality scene comprises:
providing the virtual reality scene including the plurality of objects to permit the user device to filter objects other than the particular set of objects from the virtual reality scene.

3. The method of claim 1, where an object, of the plurality of objects, is associated with two or more different roles.

4. The method of claim 1, where providing the virtual reality scene including the particular set of objects comprises:
providing information identifying a physical identifier associated with a particular object of the particular set of objects,
the physical identifier to correspond to a physical object in a vicinity of the user device, and
the user device to provide the particular object in the virtual reality scene based on detecting the physical identifier.

5. The method of claim 1, further comprising:
receiving a modification to the virtual reality scene;
determining that the modification relates to a particular object of the particular set of objects; and
providing the particular object to the user device for inclusion in the virtual reality scene based on the modification.

6. The method of claim 5, where the particular object relates to a plurality of roles including the particular role; and
where the method further comprises:
identifying a plurality of user devices associated with one or more roles of the plurality of roles; and
providing the particular object to the plurality of user devices for inclusion in the virtual reality scene based on the plurality of user devices being associated with the one or more roles and based on the modification.

7. A device, comprising:
one or more processors to:
determine role information identifying a particular role associated with a user device;
identify a virtual reality scene to be provided to the user device based on the role information and/or the user device,
the virtual reality scene including a plurality of objects,
sets of objects, of the plurality of objects, being associated with information identifying respective roles associated with the sets of objects;
identify a particular set of objects, of the sets of objects, to be provided to the user device as a part of the virtual reality scene based on the particular role; and
provide, to the user device, the virtual reality scene including the particular set of objects.

8. The device of claim 7, where the one or more processors are further to:
provide a notification to the user device indicating that the user device is to receive the virtual reality scene including the particular set of objects.

9. The device of claim 7, where the particular set of objects is relevant to the particular role.

10. The device of claim 7, where the one or more processors, when providing the virtual reality scene including the particular set of objects, are to:
provide the virtual reality scene including the plurality of objects to permit the user device to filter objects other than the particular set of objects from the virtual reality scene.

11. The device of claim 7, further comprising:
receiving information identifying one or more modified objects associated with the particular role; and
provide the one or more modified objects to the user device for inclusion in the virtual reality scene.

12. The device of claim 7, where the one or more processors, when determining the role information, are to:
receive the role information from the user device.

13. The device of claim 7, where the one or more processors, when determining the role information, are to:
determine the role information based on information indicating that a user of the user device is to view the virtual reality scene according to a set of roles that includes the particular role.

14. The device of claim 7, where the one or more processors, when determining the role information, are to:
determine the role information based on a location of the user device.

15. A non-transitory computer-readable medium storing instructions, the instructions comprising:
one or more instructions that, when executed by one or more processors, cause the one or more processors to:
determine role information identifying a role associated with a user device,
the role relating to a virtual reality scene to be provided to a user associated with the user device;
identify the virtual reality scene to be provided to the user device based on the role information,
the virtual reality scene including a plurality of objects,
sets of objects, of the plurality of objects, being associated with information identifying respective roles associated with the sets of objects;
identify a particular set of objects, of the sets of objects, to be provided to the user device as a part of the virtual reality scene based on the role; and
provide, to the user device, the virtual reality scene including the particular set of objects to permit the user device to provide the virtual reality scene to the user.

16. The non-transitory computer-readable medium of claim 15, where the one or more instructions, that cause the one or more processors to provide the virtual reality scene including the particular set of objects, cause the one or more processors to:
provide information identifying a physical identifier associated with a particular object of the particular set of objects,
the physical identifier to correspond to a physical object in a vicinity of the user device, and
the user device to provide or modify the particular object in the virtual reality scene based on detecting the physical identifier.

17. The non-transitory computer-readable medium of claim 15, where the virtual reality scene relates to a change management operation.

18. The non-transitory computer-readable medium of claim 15, where the one or more instructions, when executed by the one or more processors, cause the one or more processors to:
determine whether the user device has permission to access the virtual reality scene associated with the role; and
where the one or more instructions, that cause the one or more processors to provide the virtual reality scene, cause the one or more processors to:
selectively provide the virtual reality scene to the user device based on determining whether the user device has permission to access the virtual reality scene,
the virtual reality scene to be provided when the user device has permission to access the virtual reality scene, and
the virtual reality scene not to be provided when the user device does not have permission to access the virtual reality scene.

19. The non-transitory computer-readable medium of claim 15, where the one or more instructions, that cause the one or more processors to determine the role information, cause the one or more processors to:
determine the role information based on information identifying the user associated with the user device.

20. The non-transitory computer-readable medium of claim 15, where the one or more instructions, that cause the one or more processors to determine the role information, cause the one or more processors to:
identify multiple, different roles associated with the user device; and
where the one or more instructions, that cause the one or more processors to provide the virtual reality scene, cause the one or more processors to:
provide, to the user device, multiple, different sets of objects associated with the multiple, different roles.
